(19) United States
(12) Patent Application Publication
(10) Pub. No.: US 2025/0360854 A1
(43) Pub. Date: Nov. 27, 2025

(54) HEADREST WITH VIBRATION ISOLATION

(71) Applicant: Toyota Motor Engineering & Manufacturing North America, Inc., Plano, TX (US)

(72) Inventors: Paul A. Gilmore, Howell, MI (US); Umesh N. Gandhi, Farmington Hills, MI (US); Yasushi Dohnoue, Seto-city Aichi (JP); Michio Arakawa, Odawara city Kanagawa (JP); Kohshi Katoh, Hadano city Kanagawa (JP); Yukiko Ohnishi, Nagoya city Aichi (JP)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/671,413

(22) Filed: May 22, 2024

(51) Int. Cl. B60N 2/80

(52) U.S. Cl. CPC B60N 2/80; B60N 2002/899

(57) ABSTRACT

A headrest can include a first headrest structure and a second headrest structure. A vibration isolator can be operatively positioned between the first headrest structure and the second headrest structure. The vibration isolator can be configured to exhibit a non-linear stiffness profile. The non-linear stiffness profile includes a region of quasi-zero stiffness.

### FIELD

The subject matter described herein relates in general to vibration isolators and, more particularly, to vibration isolators for use in connection with a headrest.

### BACKGROUND

A vehicle typically includes a plurality of seats. There are numerous vehicle seat designs. Vehicles seats can be configured to provide support and comfort to a vehicle occupant. A vehicle seat can include a headrest to support a seat occupant's head. Some seats can include various ergonomic features to enhance user comfort.

### SUMMARY

In one respect, the present disclosure is directed to a headrest. The headrest includes a first headrest structure, a second headrest structure, and a vibration isolator operatively positioned between the first headrest structure and the second headrest structure. The vibration isolator can be configured to exhibit a non-linear stiffness profile. The non-linear stiffness profile includes a region of quasi-zero stiffness.

In another respect, the present disclosure is directed to a headrest. The headrest includes a first headrest structure and a second headrest structure. The headrest includes a vibration isolator operatively positioned between the first headrest structure and the second headrest structure. The vibration isolator includes a first isolator member configured to exhibit a positive stiffness profile and a second isolator member configured to exhibit a negative stiffness profile. The first isolator member and the second isolator member can be operatively connected to each other to define a non-linear stiffness profile, which includes a region of quasi-zero stiffness. The headrest includes a connecting structure operatively connected to the first headrest structure and the second headrest structure. The connecting structure can be configured to constrain a movement of the first headrest structure relative to the second headrest structure.

### BRIEF DESCRIPTION OF THE DRAWINGS

FIG. 1 shows an example of a headrest with vibration isolation.

FIG. 2 is another example of a headrest with vibration isolation.

FIG. 3 is a view of a portion of the headrest with vibration isolation, showing an arrangement with a plurality of multi-bar linkages.

FIG. 4 is another view of the portion of the headrest with vibration isolation of FIG. 3.

FIG. 5 is a view of a portion of the headrest with vibration isolation, showing an arrangement with one multi-bar linkage.

FIG. 6 is another view of the portion of the headrest with vibration isolation of FIG. 5.

FIG. 7 is an example of a manner of achieving a stiffness profile including a region of quasi-zero stiffness by combining a negative stiffness mechanism and a positive stiffness mechanism.

FIG. 8 is an example of a graph of transmissibility versus frequency, comparing the performance of a regular headrest and a headrest with vibration isolation according to arrangements described herein.

FIG. 9 is an example of a graph of force versus displacement showing a curve with a non-linear stiffness profile including a region of quasi-zero stiffness.

FIG. 10A shows a first example of a negative stiffness mechanism.

FIG. 10B shows a second example of a negative stiffness mechanism.

FIG. 10C shows a third example of a negative stiffness mechanism.

FIG. 10D shows a fourth example of a negative stiffness mechanism.

### DETAILED DESCRIPTION

While a vehicle is in use, there are various forces that act upon the vehicle. These forces may be transmitted from the vehicle chassis to seats where the occupants are sitting. Headrests may be prone to vibrations transmitted from the seat. Such vibrations may be felt by the seat occupants and, at least in some instances, can be especially irritating.

Thus, arrangements described herein are directed to reducing the transfer of vibrations to vehicle occupants by a headrest. Arrangements described are directed to a headrest. The headrest can include a first headrest structure and a second headrest structure. A vibration isolator can be operatively positioned between the first headrest structure and the second headrest structure. The vibration isolator can be configured to exhibit a non-linear stiffness profile that includes a region of quasi-zero stiffness. As a result of these arrangements, headrest vibration can be reduced and passenger comfort can be improved.

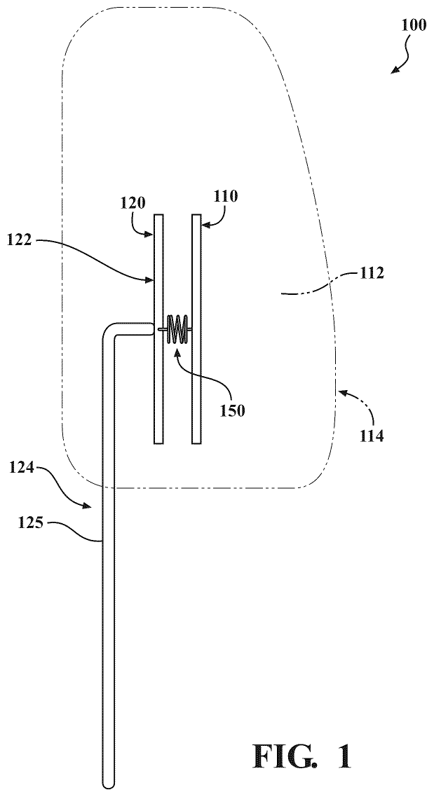

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example representation of a headrest 100 with vibration isolation is shown. The headrest 100 can include a headrest plate 110 and a headrest shaft 120. One or more vibration isolators 150 can be operatively positioned between the headrest plate 110 and the headrest shaft 120. Each of these elements will be discussed in turn below.

The headrest plate 110 can be configured to support a seat occupant's head and neck, thereby providing comfort and/or safety to the seat occupant. The headrest plate 110 can be made of any suitable material, such as metal, plastic, wood, or other material. The headrest plate 110 can have any suitable size, shape, and/or configuration. In some arrangements, the headrest plate 110 can be substantially rectangular, but other shapes are possible, such as substantially circular, substantially oval, substantially obround, or substantially polygonal, just to name a few possibilities. Further, while the term “plate” may connote a flat, plate-like structure, the headrest plate 110 is not limited to any particular geometry. Indeed, the headrest plate 110 can include one or more non-flat and/or non-planar features, including one or more curves, bends, angles, protrusions, etc.

The headrest plate 110 can include a cushioned portion 112. The cushioned portion 112 can provide a supporting, padded, and/or compliant surface for use in supporting a passenger's head and neck. The cushioned portion 112 can include foam, gel, feathers, padding, etc. In some arrangements, the cushioned portion 112 can include an outer cover 114, which can include upholstery.

The headrest plate 110 and the cushioned portion 112 can have any suitable relationship. For instance, the headrest plate 110 can be operatively connected to the cushioned portion 112, such as by one or more fasteners, one or more adhesives, one or more forms or mechanical engagement, one or more other forms of attachment, or any combination thereof. In some arrangements, a portion of the headrest plate 110 can be received in the cushioned portion 112.

The headrest shaft 120 can be configured to connect the headrest to a seat. The headrest shaft 120 can include an attachment portion 122 and a shaft portion 124. The attachment portion 122 can be operatively connected to the headrest plate 110. The shaft portion 124 can extend from the attachment portion 122. In some arrangements, the shaft portion 124 can include one or more posts 125. In some arrangements, the shaft portion 124 can include two posts. In some arrangements, the post(s) 125 can be received in engaging opening(s) in a back portion of a seat. The post(s) 125 can be retainably engaged by the seat in any suitable manner, now known or later developed. Such retainable engagement can be selectively released in any suitable manner, now known or later developed. In some arrangements, the position of the headrest 100 relative to the seat can be adjusted.

It should be noted that the back portion of the seat can be reclined. The headrest 100 can recline with the back portion of the seat. In some arrangements, the back portion of the seat can have a maximum reclined position and a corresponding recline angle relative to horizontal.

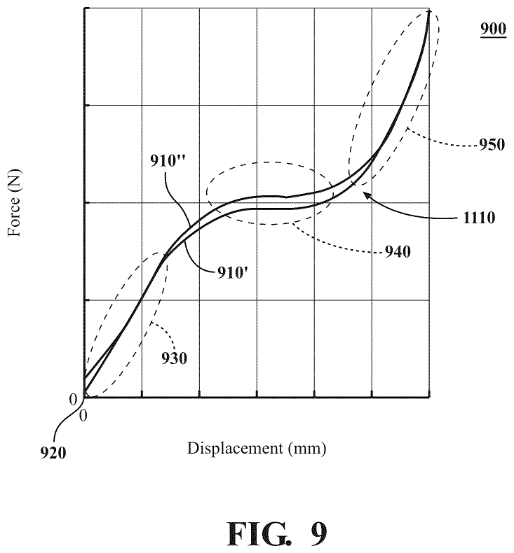

The vibration isolator(s) 150 can be any type of vibration isolator, now known or later developed. Some examples of the vibration isolator(s) 150 will be described herein. The vibration isolator 150 can be configured to exhibit a non-linear stiffness profile. The non-linear stiffness profile can include a region of quasi-zero stiffness. An example of a force-displacement graph for this type of actuator is shown in FIG. 9. The force-deflection graph 900 is merely one example, as the values will vary depending on various characteristics of the vibration isolator. However, the general shape of a force-deflection curve 910, representing the stiffness profile, is shown. Starting from the origin 920, the vibration isolator 150 can exhibit an initial stiffness region 930 that is substantially linear. The vibration isolator 150 can be relatively stiff in the initial stiffness region 930. When load is reached, the force-deflection curve 910 can become horizontal. Thus, the stiffness can be zero or substantially zero, which is a quasi-zero stiffness region 940. The quasi-zero stiffness region 940 can allow for good vibration isolation. Continuing beyond the quasi-zero stiffness region 940, the force-deflection curve 910 can have a subsequent stiffness region 950 that is substantially linear. The vibration isolator 150 can be relatively stiff in the subsequent stiffness region 950.

It should be noted that there are two force-displacement curves shown in FIG. 9. A first force-deflection curve 910′ represents the vibration isolator 150 going from a non-loaded state to a loaded state. A second force deflection curve 910″ represents the vibration isolator(s) 150 going from a loaded state to a non-loaded state.

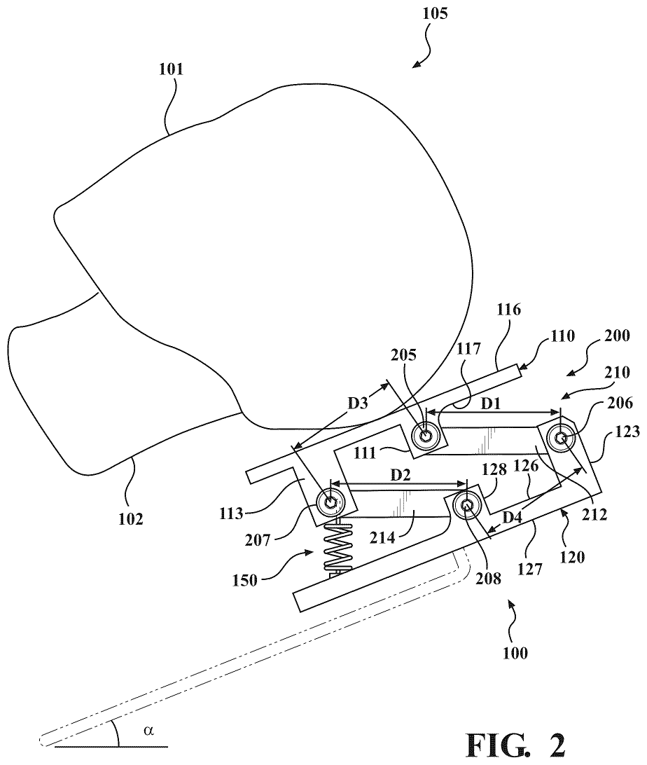

FIG. 2 shows another example representation of the headrest 100 with vibration isolation. Again, the headrest 100 includes a headrest plate 110 and a headrest shaft 120. The headrest plate 110 can be spaced from the headrest shaft 120. Other portions of the headrest 100, such as the cushioned portion, are omitted for clarity.

The headrest plate 110 can be substantially parallel to the headrest shaft 120. More particularly, a passenger facing surface 116 of the headrest plate 110 can be substantially parallel to the headrest shaft 120. Still more particularly, the passenger facing surface 116 of the headrest plate 110 can be substantially parallel to an inner surface 126 and/or an outer surface 127 of the headrest shaft 120. The passenger facing surface 116 refers to a surface of the headrest plate 110 that faces toward a seat occupant. The passenger facing surface 116 can directly or indirectly contact a head 101 and/or a neck 102 of a seat occupant 105. In some arrangements, the passenger facing surface 116 can be substantially flat or substantially planar.

The headrest plate 110 can be operatively connected to the headrest shaft 120. The headrest plate 110 can be moveably relative to the headrest shaft 120. The headrest 100 can include one or more connecting structures 200 configured to prescribe the motion of the headrest plate 110 relative to the headrest shaft 120. Thus, the connecting structure(s) 200 can guide the headrest plate 110 in a controlled motion. The connecting structure(s) 200 can create lateral strength in the assembly. The connecting structure(s) 200 can resist lateral movement of the headrest plate 110 and/or the headrest shaft 120.

The connecting structure(s) 200 can be operatively connected to the headrest plate 110 and the headrest shaft 120. In some arrangement, the connecting structure(s) 200 can be configured to maintain the headrest plate 110 and the headrest shaft 120 substantially parallel to each other. More particularly, the connecting structure(s) 200 can be configured to maintain the headrest plate 110 and the headrest shaft 120 substantially parallel to each other throughout the range of movement of the headrest plate 110 relative to the headrest shaft 120. The connecting structure(s) 200 can be provided in any suitable location between the headrest plate 110 and the headrest shaft 120.

The connecting structure(s) 200 can be any suitable structure, now known or later developed. In one or more arrangements, the connecting structure(s) 200 can include a plurality of linkages. Thus, the connecting structure(s) 200 can be a multi-bar linkage 210. The term “multi-bar” includes two or more linkages. In some arrangements, the multi-bar linkage 210 can be a four-bar linkage. In some arrangements, there can be a single multi-bar linkage 210. In other arrangements, there can be a plurality of multi-bar linkages 210.

In the arrangement shown in FIG. 2, the multi-bar linkage 210 can include a first linkage member 212 and a second linkage member 214. In one or more arrangements, the first linkage member 212 and the second linkage member 214 can be substantially identical to each other. The headrest plate 110 and the headrest shaft 120 can also be considered to be linkages. In such case, the first linkage member 212, the second linkage member 214, the headrest plate, and the headrest shaft 120 can collectively form a four bar linkage.

A first end portion of the first linkage member 212 can be operatively connected to a first post member 111 of the headrest plate 110 at a connection point 205. Any suitable form of operative connection can be provided. In some instances, the first post member 111 can be a pair of posts, and the first end portion of the first linkage member 212 can be received between the pair of posts. The first post member 111 and the first end of the first linkage member 212 can be operatively connected. For instance, a fastener can be received in aligned apertures in the first post member 111 and the first end portion of the first linkage member 212.

A second end portion of the first linkage member 212 can be operatively connected to a first post member 123 of the headrest shaft 120 at a connection point 206. The connection point 205 and the connection point 206 can be spaced at a distance D1. Any suitable form of operative connection can be provided. In some instances, the first post member 123 can be a pair of posts, and the second end portion of the first linkage member 212 can be received between the pair of posts. The first post member 123 and the second end portion of the first linkage member 212 can be operatively connected. For instance, a fastener can be received in aligned apertures in the first post member 123 and the second end portion of the first linkage member 212.

A first end portion of the second linkage member 214 can be operatively connected to a second post member 113 of the headrest plate 110 at a connection point 207. Any suitable form of operative connection can be provided. In some instances, the second post member 113 can be a pair of posts, and the first end portion of the second linkage member 214 can be received between the pair of posts. The second post member 113 and the first end portion of the second linkage member 214 can be operatively connected. For instance, a fastener can be received in aligned apertures in the second post member 113 and the first end portion of the second linkage member 214.

A second end portion of the second linkage member 214 can be operatively connected to a second post member 128 of the headrest shaft 120 at a connection point 208. The connection point 207 and the connection point 208 can be spaced at a distance D2. In some arrangements, the distance D1 and the distance D2 can be substantially equal.

The connection point 207 and the connection point 205 can be spaced at a distance D3. The connection point 208 and the connection point 206 can be spaced at a distance D4. In some arrangements, the distance D3 and the distance D4 can be substantially equal.

Any suitable form of operative connection can be provided. In some instances, the second post member 128 can include a pair of posts, and the second end portion of the second linkage member 214 can be received between the pair of posts. The second post member 128 and the second end portion of the second linkage member 214 can be operatively connected. For instance, a fastener can be received in aligned apertures in the second post member 128 and the second end portion of the second linkage member 214.

In some arrangements, the operative connections between the linkage members and the posts can enable pivotable movement of the first linkage member 212 and the second linkage member 214 relative to the headrest plate 110 and the headrest shaft 120. In such instances, the first linkage member 212 and the second linkage member 214 can be pivotably connected to the headrest plate 110 and the headrest shaft 120.

The vibration isolator(s) 150 can be operatively positioned between the headrest plate 110 and the headrest shaft 120. The vibration isolator 150 can be oriented between the headrest plate 110 and the headrest shaft 120 in any suitable manner. For instance, the vibration isolator 150 can be oriented at substantially 90 degrees between the headrest plate 110 and the headrest shaft 120. In other arrangements, the vibration isolator 150 can be oriented at an angle that corresponds to a recline angle a of a seat, such as about 45 degrees or less, about 40 degrees or less, about 35 degrees or less, about 30 degrees or less, about 25 degrees or less, or about 20 degrees or less. In some arrangements, the recline angle a can be the maximum recline angle of the seat.

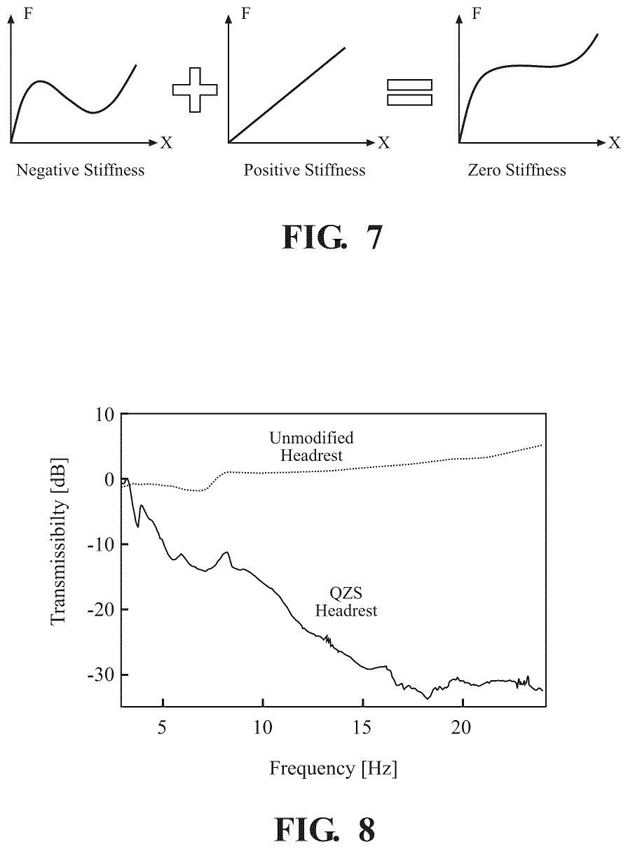

As noted above, the vibration isolator(s) 150 can be configured to exhibit a non-linear stiffness profile that includes a region of quasi-zero stiffness. Such a stiffness profile can be achieved in various ways. For instance, in one or more arrangements, the stiffness profile can be achieved by using a plurality of isolator members. As an example, FIG. 7 is an example of one manner of achieving vibration isolator with a stiffness profile including a region of quasi-zero stiffness. In this example, the vibration isolator combines a mechanism that exhibits a negative stiffness profile 810 and a mechanism that exhibits a positive stiffness profile 820 to collectively achieve a non-linear stiffness profile 830 that includes a region of quasi-zero stiffness 832.

The mechanism that exhibits a negative stiffness profile can be a first isolator member. The mechanism that exhibits a positive stiffness profile can be a second isolator member. The first isolator member and the isolator member can be operatively connected in parallel with each other. The negative slope 812 of the negative stiffness profile 810 can substantially match the positive slope 822 of the positive stiffness profile 820. In this way, the stiffness profiles can cancel each other out to define a zero slope region, which corresponds to the region of quasi-zero stiffness 832.

The first isolator member can be configured to exhibit a positive stiffness profile. In one or more arrangements, the first isolator member can be a spring, such as a linear spring, compression spring, or coil spring. The first isolator member can have a single spring constant k.

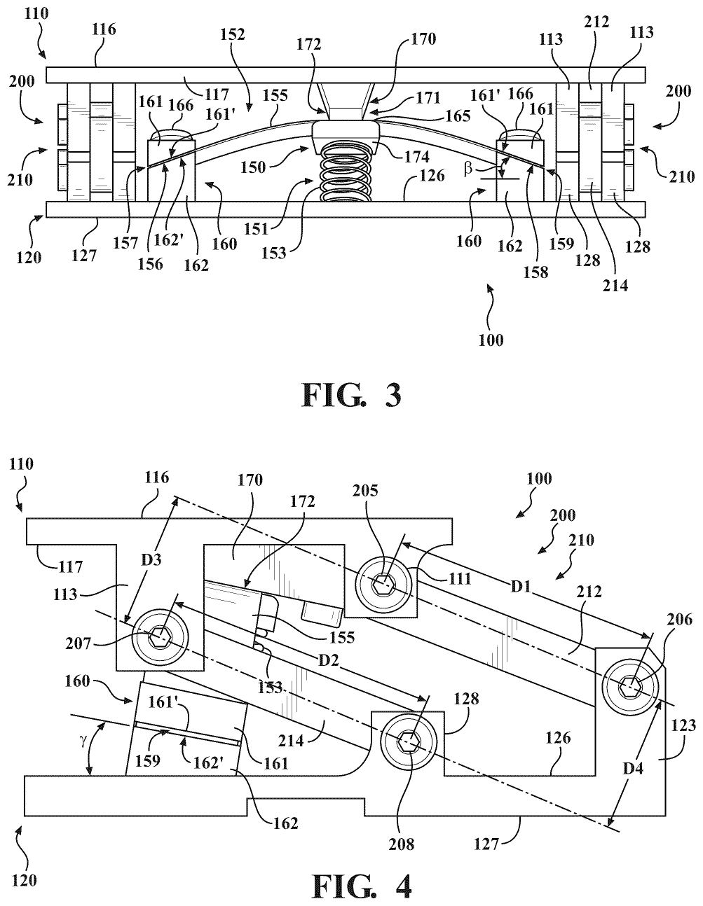

The second isolator member can be configured to exhibit a negative stiffness profile. In one or more arrangements, the second vibration isolator can be a structure made of a spring material, such as spring steel or other material that can allow the structure to substantially return to its original shape after being buckled, arched, bowed, deflected, twisted, and/or otherwise manipulated from its original shape. The structure can be arched. In one or more arrangements, the structure can be a piece of spring steel that is arched and held in an arched configuration. An example of an arched spring structure is described in connection with FIGS. 3-6, which will be described later.

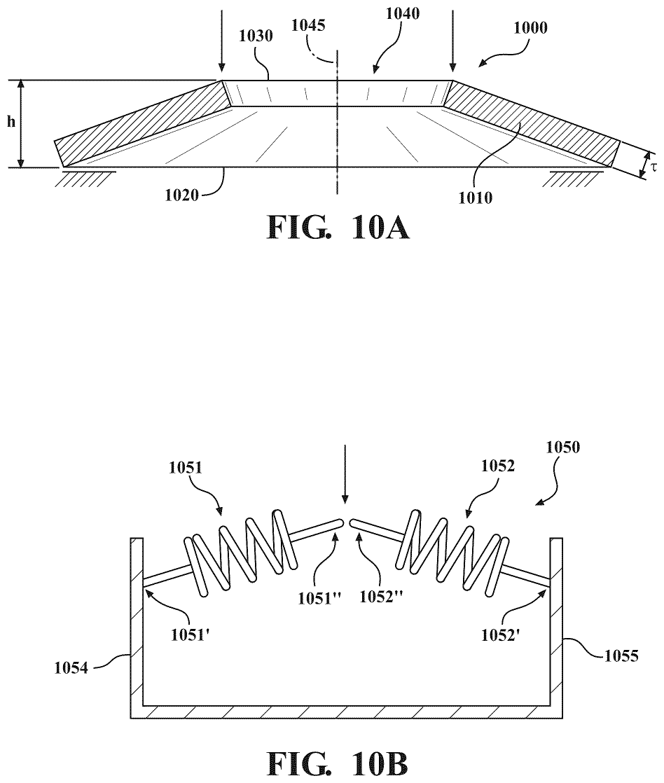

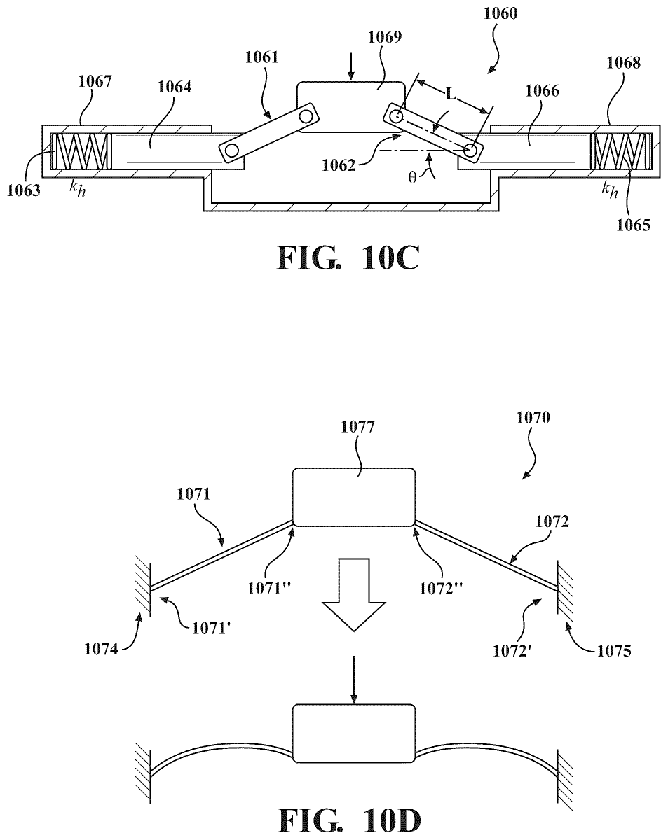

Referring to FIGS. 10A-10D, various examples of negative stiffness mechanisms are shown. The second vibration isolator can be any one or more of these negative stiffness mechanisms. Each of these examples will be addressed in turn below.

Referring to FIG. 10A, the second vibration isolator be one or more conical springs 1000. The conical spring 1000 can have a body 1010 with a substantially conical shape. The conical spring 1000 can include an outer diameter body portion 1020 and an inner diameter body portion 1030. The outer diameter body portion 1020 can be larger than the inner diameter body portion 1030. The conical spring 1000 can have a central aperture 1040. The conical spring 1000 can have a central axis 1045. The conical spring 1000 can have a height h and a thickness τ. The conical spring 1000 can have a height to thickness ratio h/τ of greater than 1.41.

In some arrangements, a plurality of the conical springs 1000 can be arranged in any suitable manner in a stack. For instance, in one or more arrangements, the plurality of the conical springs 1000 can be arranged in an alternating pattern. For example, the outer diameter body portion 1020 of one conical spring 1000 can face the outer diameter body portion 1020 of a neighboring conical spring 1000. Alternatively or additionally, the inner diameter body portion 1030 of a conical spring 1000 can face the inner diameter body portion 1030 of a neighboring conical spring 1000. The central apertures 1040 of the plurality of conical springs 1000 can be substantially aligned with each other.

In some arrangements, one or more of conical springs 1000 can be operatively connected to the first isolator member. In some arrangements, one or more conical springs 1000 can be operatively positioned relative to the first isolator member.

In FIG. 10B, the second vibration isolator can be an arrangement of oblique springs 1050. In some arrangements, the oblique springs 1050 can be arranged in pairs. There can be one or more pairs of oblique springs 1050. In the example shown, there can be a first oblique spring 1051 and a second oblique spring 1052. The first oblique spring 1051 and a second oblique spring 1052 can be substantially identical to each other. Alternatively, the first oblique spring 1051 and a second oblique spring 1052 can be different from each other in one or more respects.

A first end 1051′ of the first oblique spring 1051 can be operatively connected to a fixed structure 1054, and a first end 1052′ of the second oblique spring 1052 can be operatively connected to a fixed structure 1055. In some instances, the fixed structure 1054 and the fixed structure 1055 can be the same structure. In other instances, the fixed structure 1054 and the fixed structure 1055 can be different structures. A second end 1051″ of the first oblique spring 1051 and a second end 1052″ of the second oblique spring 1052 can be operatively connected to each other or to a common structure. In some arrangements, the common structure can be the first isolator member, or the common structure can be operatively connected to the first isolator member. The first oblique spring 1051 can be angled relative to a fixed structure 1054, and the second oblique spring 1052 can be angled relative to the fixed structure 1055. In some arrangements, the first oblique spring 1051 and the second oblique spring 1052 can be at substantially the same angle.

In FIG. 10C, the second isolator member can be an arrangement 1060 of a plurality of oblique links operatively connected to linear springs. The linear springs can be oriented substantially horizontally or substantially laterally, as is shown in FIG. 10C. The plurality of oblique links can include a first link member 1061 and a second link member 1062. The first link member 1061 and the second link member 1062 can be substantially identical to each other. In one or more arrangements, the distance L between the connection points of the first link member 1061 and the second link member 1062 can be substantially identical.

The first link member 1061 can be operatively connected to a first spring member 1063. The first spring member 1063 can be a linear spring or any other type of spring element. In some arrangements, the first spring member 1063 can be directly connected to the first link member 1061. In other arrangements, the first spring member 1063 can be indirectly connected to the first link member 1061, such as by one or more intermediate structures 1064.

The second link member 1062 can be operatively connected to a second spring member 1065. The second spring member 1065 can be a linear spring or any other type of spring element. In some arrangements, the second spring member 1065 can be directly connected to the second link member 1062. In other arrangements, the second spring member 1065 can be indirectly connected to the second link member 1062, such as by one or more intermediate structures 1066.

The first link member 1061 and the second link member 1062 can be at angle Θ relative to horizontal or relative to the movement direction of the first spring member 1063 and the second spring member 1065. In some arrangements, the angle Θ of the first link member 1061 and the second link member 1062 can be substantially identical.

In some arrangements, the first spring member 1063 and the second spring member 1065 can be received in a passage 1067, 1068, respectively. Thus, the movement of the first spring member 1063 and the second spring member 1065 can be constrained. The first spring member 1063 and the second spring member 1065 can be substantially aligned with each other, as shown in FIG. 10C. In some arrangements, the first spring member 1063 and the second spring member 1065 can be substantially identical to each other. More particularly, the first spring member 1063 and the second spring member 1065 can have substantially the same spring constant.

In some arrangements, the first spring member 1063 and the second spring member 1065 can be operatively connected to each other or to a common structure 1069. In some arrangements, the common structure 1069 can be the first isolator member, or the common structure 1069 can be operatively connected to the first isolator member.

Referring to FIG. 10D, another example of the second vibration isolator is shown. In this example, the second vibration isolator can be an oblique beam 1070. The oblique beam 1070 can include a plurality of oblique beams. In this example, the oblique beam 1070 can include a first beam member 1071 and a second beam member 1072. The first beam member 1071 and a second beam member 1072 can be substantially identical to each other. Alternatively, one or more of the beam members can be different from the other beam members in one or more respects.

A first end 1071′ of the first beam member 1071 can be operatively connected to a fixed structure 1074, and a first end 1072′ of the second beam member 1072 can be operatively connected to a fixed structure 1075. In some instances, the fixed structure 1074 and the fixed structure 1075 can be the same structure. In other instances, the fixed structure 1074 and the fixed structure 1075 can be different structures. A second end 1071″ of the first beam member 1071 and a second end 1072″ of the second beam member 1072 can be operatively connected to each other or to a common structure 1077. In some arrangements, the common structure 1077 can be the first isolator member, or the common structure 1077 can be operatively connected to the first isolator member.

The first beam member 1071 and a second beam member 1072 can be angled relative to horizontal. When a load is applied to the oblique beam 1070, the beam members can buckled as is shown in FIG. 10D.

It should be noted that, in some arrangements, the vibration isolator(s) 150 can be configured to enter the quasi-zero stiffness region of the non-linear stiffness profile when loaded (e.g., when a user's head and/or neck is supported on the headrest, particularly when reclined). In some arrangements, the vibration isolator(s) 150 can be pre-loaded to be in the quasi-zero stiffness region of the non-linear stiffness profile. In such case, when subjected to expected operational loads, the vibration isolator(s) 150 can remain in the quasi-zero stiffness region of the non-linear stiffness profile.

More particular examples of the vibration isolator will now be described. Referring to FIGS. 3-4, a portion of the headrest 100 is shown. The headrest 100 can include the headrest plate 110 and the headrest shaft 120. The headrest plate 110 can be spaced from the headrest shaft 120. The headrest plate 110 can include the passenger facing surface 116 and an inner surface 117. In some arrangements, the passenger facing surface 116 can be substantially flat or substantially planar. One or more posts (e.g., the first post member 111, the second post member 113, etc.) can extend from the inner surface 117. The headrest shaft 120 can include an inner surface 126 and an outer surface 127. In some arrangements, the outer surface 127 can be substantially flat or substantially planar. One or more posts (e.g., the first post member 123, the second post member 128, etc.) can extend from the inner surface 117. The terms “inner” and “outer” are used in this context for convenience to refer to the relative position of the surface to the vibration isolator(s) 150. Such terms are not intended to be limiting.

In this arrangement, there can be a plurality of connecting structures 200 (e.g., multi-bar linkages 210) operatively connecting the headrest plate 110 and the headrest shaft 120. The multi-bar linkages 210 can be located in the laterally outboard regions of the space between the headrest plate 110 and the headrest shaft 120. The multi-bar linkages 210 can be substantially aligned with each other in a lateral direction. As noted above, the multi-bar linkages 210 can constrain the motion of the headrest plate 110 relative to the headrest shaft 120. Further, the multi-bar linkages 210 can maintain the passenger facing surface 116 substantially parallel to the outer surface 127 and/or the inner surface 126 throughout the range of motion of the headrest plate 110. The description of the connecting structure(s) 200 and the multi-bar linkages 210 in connection with FIG. 2 applies equally here.

The headrest 100 can include the vibration isolator 150. The vibration isolator 150 can be substantially centrally located in the space between the headrest plate 110 and the headrest shaft 120.

The vibration isolator 150 can including a first isolator member 151 and a second isolator member 152. The first isolator member 151 can be operatively connected to the second isolator member 152.

In this example, the first isolator member 151 can be a compression spring 153. The compression spring 153 can be angled relative to the inner surface 126 of the headrest shaft 120. The angle can substantially match an angle of the second isolator member 152.

In this example, the second isolator member 152 can be a structure made of a spring material. For instance, the second isolator member 152 can be a spring material member 155. In one or more arrangements, the spring material member 155 can be a piece of spring steel. The spring material member 155 can be a relatively thin structure. The spring material member 155 can have any suitable size, shape, and/or configuration. In some arrangements, the spring material member 155 can be substantially rectangular.

The spring material member 155 can be arched or pre-buckled, as is shown in FIG. 3. The spring material member 155 can include a first end region 156 including a first end 157. The spring material member 155 can include a second end region 158 including a second end 159. There can be apertures in the spring material member 155 in the first end region 156 and the second end region 158.

The first end region 156 and the second end region 158 of the spring material member 155 can be constrained. As an example, the first end region 156 and the second end region 158 of the spring material member 155 can be constrained by clamping blocks 160. The clamping blocks 160 can be operatively connected to the headrest shaft 120. For instance, the clamping blocks 160 can be formed together with the headrest shaft 120 as a unitary structure. Alternatively, the clamping blocks 160 can be formed separately and subsequently connected to the headrest shaft 120, such as by one or more fasteners, one or more adhesives, one or more welding, one or more brazing, one or more forms of mechanical engagement, or any combination thereof.

The clamping blocks 160 can have any suitable size, shape, and/or configuration. For instance, the clamping blocks 160 can include a first portion 161 and a second portion 162. The first end region 156 and the second end region 158 of the spring material member 155 can be sandwiched between the first portion 161 and the second portion 162 of the clamping blocks 160. The first portion 161 and the second portion 162 can be held together by one or more fasteners, such as a screw 166. The fastener can pass through apertures in the first portion 161, the second portion 162, and an aperture in the spring material member 155.

The spring material member 155 can be arched as shown in FIG. 3. The spring material member 155 can includes a substantially flat region 165 or a substantially zero slope region. The substantially flat region 165 can be substantially centrally located on the spring material member 155. In some arrangements, the substantially flat region 165 can be substantially parallel with the passenger facing surface 116 of the headrest plate 110, the inner surface 117 of the headrest plate 110, the inner surface 126 of the headrest shaft 120, and the outer surface 127 of the headrest shaft 120.

The first isolator member 151 can be operatively positioned between the second isolator member 152 and the headrest shaft 120. The first isolator member 151 (e.g., the compression spring 153) can be operatively connected to and/or operatively positioned with respect to the spring material member 155. More particularly, the first isolator member 151 can be operatively connected to and/or operatively positioned with respect to the substantially flat region 165 of the spring material member 155.

Further, the spring material member 155 can be operatively connected to the headrest plate 110, such as to the inner surface 117. In one or more arrangements, there can be a connector 170 that is operatively connected to the headrest plate 110. The connector 170 can include an engaging portion 171 configured to maintain the substantially flat region 165 of the spring material member 155 as substantially flat or substantially zero slope. For instance, the engaging portion 171 can include a slot 172 into which the spring material member 155 is received. Thus, while movement of the headrest plate 110 can cause some movement and/or deflection of the spring material member 155, the connector 170 can maintain the substantially flat region 165 of the spring material member 155. By maintaining the substantially flat region 165, the buckling mode of the spring material member 155 can be controlled. Also, undesired buckling modes can be avoided, such as asymmetric buckling. In one or more arrangements, the connector 170 can be configured to facilitate a substantially symmetrical buckling of the spring material member 155. The connector 170 can provide a surface 174 against which the compression spring 153 can operate against.

The compression spring 153 can be operatively connected to the connector 170. Thus, in one or more arrangements, the compression spring 153 can be operatively positioned between the connector 170 and the inner surface 126 of the headrest shaft 120.

The first end region 156 and the second end region 158 of the spring material member 155 can be oriented at an angle β relative to at least one of the inner surface 126, the outer surface 127, the inner surface 117, and the passenger facing surface 116. For instance, the angle β can be selected depending on the desired characteristics of the spring material member 155. It will be appreciated that, by changing the angle β, different force-deflection characteristics of the spring material member 155 can be achieved. In one or more arrangements, the angle β can be about 45 degrees or less, about 40 degrees or less, about 35 degrees or less, about 30 degrees or less, about 25 degrees or less, about 20 degrees or less, about 15 degrees or less, about 10 degrees or less, about 5 degrees or less, or any range thereof.

The first end region 156 and the second end region 158 of the spring material member 155 can be held in their angled position by the clamping blocks 160. To that end, the first portion 161 and the second portion 162 of the clamping blocks can have interfacing surfaces 161′, 162′ at the desired angle. The interfacing surfaces 161′, 162′ can clamp against the received portion of the first end region 156 and the second end region 158 of the spring material member 155. The interfacing surfaces 161′, 162′ can be complementary.

Further, the spring material member 155 can be tilted in one or more directions. For instance, the spring material member 155 can be tilted or angled relative to at least one of the inner surface 126, the outer surface 127, the inner surface 117, and the passenger facing surface 116. Accordingly, the interfacing surfaces 161′, 162′ of the clamping blocks 160 can be angled relative to at least one of the inner surface 126, the outer surface 127, the inner surface 117, and the passenger facing surface 116. For instance, as shown in FIG. 4, the interfacing surfaces 161′, 162′ can be angled at an angle γ relative to at least one of the inner surface 126, the outer surface 127, the inner surface 117, and the passenger facing surface 116. The angle γ can be any suitable angle. In one or more arrangements, the angle γ can be about 15 degrees or less, about 10 degrees or less, or about 5 degrees or less, just to name a few possibilities. The angle γ can be configured to maximize the vertical component of a force applied on the vibration isolator 150 throughout the motion of the headrest plate 110. In some arrangements, the angle γ can substantially match a maximum recline angle of a seat back of a seat.

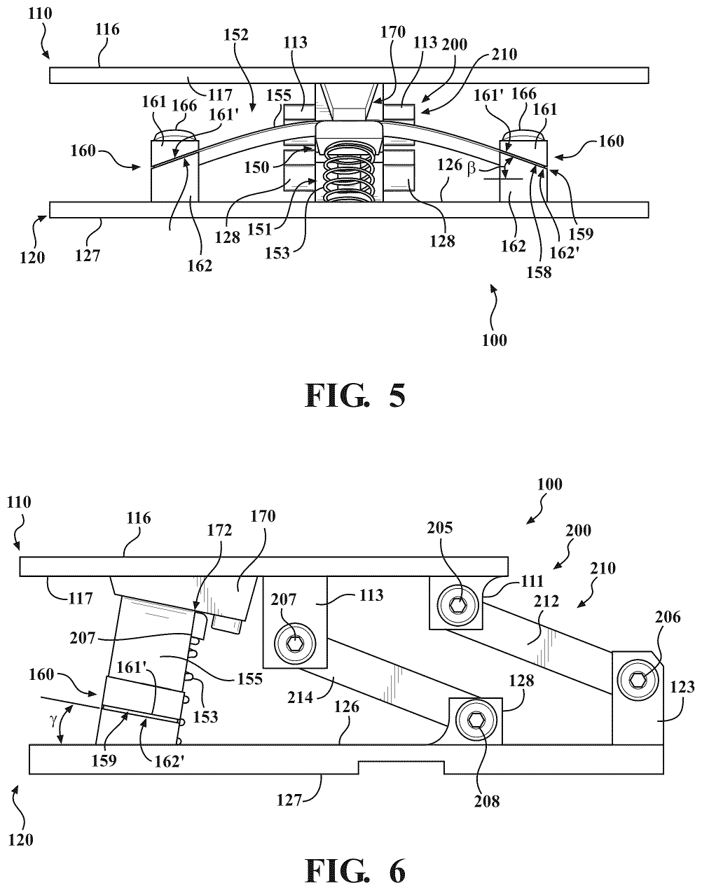

Another arrangements of the headrest 100 is shown in FIGS. 5-6. The above discussion of the arrangements of FIGS. 3-4 generally apply to this arrangement. In this arrangement, there can be a single connecting structure 200 (e.g., a single multi-bar linkage 210) operatively positioned between the headrest plate 110 and the headrest shaft 120. The multi-bar linkage 210 can be located in a central region of the space between the headrest plate 110 and the headrest shaft 120.

The multi-bar linkage 210 can be aligned with the vibration isolator 150 which can also be centrally located. In this particular arrangement, the multi-bar linkage 210 located behind the vibration isolator 150 from the view of the FIG. 5. In this arrangements, the multi-bar linkage 210 can be wider than the multi-bar linkages 210 in FIGS. 3-4 to bolster the strength of the multi-bar linkage since there is only one.

A non-limiting example of the operation of the arrangements described herein will now be explained in connection with the arrangements shown in FIGS. 3-4. For purposes of this example, the headrest 100 can begin in a non-loaded, non-reclined position. The headrest 100 is a part of a seat, such as a vehicle seat, an office chair, a chair, a massage chair, a gaming chair, a recliner, or any other seat structure, now known or later developed. The following explanation will be made in connection with a vehicle seat, but arrangements described herein are not limited to vehicle seats.

A person can sit in the seat. The head and/or neck of the person can contact the headrest 100. The person can recline the back portion of the seat, which causes the headrest 100 to recline. The headrest 100 can recline at maximum recline angle Θ (FIG. 2), which can substantially match the angle γ at which the interfacing surfaces 161′, 162′ of the headrest 100 are angled. When the seat is reclined, the force imposed by the person's head and/or neck on the headrest 100 increases. The increased force can, in some arrangements, cause the vibration isolator 150 to enter the quasi-zero stiffness region of its stiffness profile. The person's head and/or neck can be supported on the headrest 100 in the reclined position.

Under the weight of the person's head and/or neck, the headrest plate 110 of the headrest 100 can move toward the headrest shaft 120. It will be appreciated that the movement of the headrest plate 110 can be controlled by the multi-bar linkage 210. The multi-bar linkage 210 can also resist lateral movement of the headrest plate 110. While the vehicle is in operation, vibrations can develop. These vibrations can be transmitted from the vehicle seat to the headrest 100. However, since the vibration isolator 150 is operating in the quasi-zero stiffness region of its stiffness profile, the transmission of these vibrations to the headrest 100 and, more particularly, to the seat occupant can be reduced. As a result, a user's comfort can be increased.

FIG. 8 shows an example of a graph 800 of transmissibility versus frequency, comparing the performance of a regular headrest without the arrangements described herein (“Unmodified Headrest) and a headrest with vibration isolation according to arrangements described herein (“QZS Headrest”). As is evident, at most frequencies, the QZS Headrest outperforms the Unmodified Headrest.

It will be appreciated that arrangements described herein can provide numerous benefits, including one or more of the benefits mentioned herein. For example, arrangements described herein can improve the vibration performance of a headrest. Arrangement described herein can reduce vibrations of a headrest. Arrangements described here can improve comfort of a seat occupant.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A headrest comprising:
a first headrest structure;
a second headrest structure; and
a vibration isolator operatively positioned between the first headrest structure and the second headrest structure, the vibration isolator being configured to exhibit a non-linear stiffness profile, the non-linear stiffness profile including a region of quasi-zero stiffness.

2. The headrest of claim 1, wherein the vibration isolator includes:
a first isolator member configured to exhibit a positive stiffness profile; and
a second isolator member configured to exhibit a negative stiffness profile, the first isolator member and the second isolator member being operatively connected to each other to define the non-linear stiffness profile including the region of quasi-zero stiffness.

3. The headrest of claim 2, wherein the positive stiffness profile of the first isolator member substantially matches the negative stiffness profile of the second isolator member.

4. The headrest of claim 2, wherein the first isolator member is a compression spring.

5. The headrest of claim 2, wherein the second isolator member includes a spring material member arranged in an arched configuration.

6. The headrest of claim 5, wherein the spring material member includes a substantially flat region, wherein the substantially flat region is centrally located on the spring material member.

7. The headrest of claim 6, wherein the first isolator member is operatively connected to the substantially flat region of the spring material member.

8. The headrest of claim 2, wherein the second isolator member includes one or more conical springs with a height to thickness ratio of more than about 1.41.

9. The headrest of claim 2, wherein the second isolator member includes a plurality of oblique springs.

10. The headrest of claim 2, wherein the second isolator member includes a plurality of obliques links operatively connected to linear springs.

11. The headrest of claim 2, wherein the second isolator member includes a plurality of oblique beams.

12. The headrest of claim 1, further including a connecting structure operatively connected to the first headrest structure and the second headrest structure, wherein the connecting structure is configured to constrain a movement of the first headrest structure relative to the second headrest structure.

13. The headrest of claim 12, wherein the connecting structure is further configured to maintain the first headrest structure and the second headrest structure substantially parallel to each other throughout the movement of the first headrest structure relative to the second headrest structure.

14. The headrest of claim 13, wherein the connecting structure is one or more multi-bar linkages.

15. The headrest of claim 14, wherein the one or more multi-bar linkages is one multi-bar linkage, and wherein the one multi-bar linkage and the vibration isolator are centrally located between the first headrest structure and the second headrest structure.

16. The headrest of claim 14, wherein the one or more multi-bar linkages is a plurality of multi-bar linkages, wherein the vibration isolator is centrally located between the first headrest structure and the second headrest structure, and wherein the plurality of multi-bar linkages are located outboard of the vibration isolator.

17. The headrest of claim 1, wherein the first headrest structure is a headrest plate, and wherein the second headrest structure is a headrest shaft.

18. A headrest comprising:
a first headrest structure;
a second headrest structure;
a vibration isolator operatively positioned between the first headrest structure and the second headrest structure, the vibration isolator including a first isolator member configured to exhibit a positive stiffness profile and a second isolator member configured to exhibit a negative stiffness profile, the first isolator member and the second isolator member being operatively connected to each other to define a non-linear stiffness profile including a region of quasi-zero stiffness; and
a connecting structure operatively connected to the first headrest structure and the second headrest structure, the connecting structure being configured to constrain a movement of the first headrest structure relative to the second headrest structure.

19. The headrest of claim 18, wherein the first isolator member is a compression spring, and wherein the second isolator member includes a spring material member arranged in an arched configuration.

20. The headrest of claim 18, wherein the connecting structure is one or more multi-bar linkages, and wherein the connecting structure is further configured to maintain the first headrest structure and the second headrest structure substantially parallel to each other throughout the movement of the first headrest structure relative to the second headrest structure.
